(19) United States
(12) Patent Application Publication
(10) Pub. No.: US 2025/0269639 A1
(43) Pub. Date: Aug. 28, 2025

(54) MACHINE FOR POST-PROCESSING PRINTING SUBSTRATE

(71) Applicant: Heidelberger Druckmaschinen AG, Heidelberg (DE)

(72) Inventors: Tobias Hanauer, Weiden (DE); Renny Vachek, Plzen (CZ); Stefan Koller, Weiherhammer (DE)

(21) Appl. No.: 19/064,974

(22) Filed: Feb. 27, 2025

(30) Foreign Application Priority Data
Feb. 27, 2024 (EP) 24159874.7

(51) Int. Cl. B41F 19/00; B41F 5/24; B41F 21/00; B41F 33/00

(52) U.S. Cl. CPC B41F 19/008; B41F 5/24; B41F 21/00; B41F 33/00

(57) ABSTRACT

A machine post-processes a printing substrate. The machine contains a die-cutting module for die-cutting the substrate and a die-cutting device, an upstream first nipping section and a downstream second nipping section for the substrate, a transport module for onward transport of the substrate and having a variable-length transport section, and a transfer device for transferring the substrate from the die-cutting module to a stripping module and having a variable-length transfer section. The stripping module being positionable in the processing direction of the machine dependent on a sheet format. The transfer device transfers the substrate from the die-cutting module to the stripping module. A length of the transport section and a length of the transfer section are settable according to the position of the stripping module. The machine makes it possible to make changes that take little time to make and do not cause any losses in quality in subsequent production.

### CROSS-REFERENCE TO RELATED APPLICATION

This application claims the priority, under 35 U.S.C. § 119, of European Patent Application EP 24159874.7, filed Feb. 27, 2024; the prior application is herewith incorporated by reference in its entirety.

### FIELD AND BACKGROUND OF THE INVENTION

### Invention

The invention relates to a machine for post-processing printing substrate having a die-cutting module for die-cutting the printing substrate, the die-cutting module having a die-cutting device, an upstream first nipping section and a downstream second nipping section for the printing substrate, a transport module for onward transport of the printing substrate, the transport module having at least one variable-length transport section, and a transfer device for transferring the printing substrate from the die-cutting module to a subsequent module. The transfer device has a variable-length transfer section.

The invention lies in the technical field of the graphic arts industry and in particular in the sector of operating a post-processing machine, in particular a flexographic printing press with inline post-processing, for example inline flatbed die-cutting, and of processing initially web-form printing substrate, and in particular in the production of blanks for packages, particularly for folding boxes.

### Prior Art

Printing presses for package printing having inline die-cutting modules are already known, for example a flexographic printing press having a flatbed die-cutter arranged inline, wherein the machine first of all prints a cardboard web and then die-cuts sheets cross-cut therefrom to form folding-box blanks. In such machines, modifications may be necessary, with the result that the spacings of particular modules can be changed.

In this context, U.S. Pat. No. 9,828,199 B2 discloses a variable-length transfer device between a die-cutting module, or the nipping section arranged downstream therefrom, and a vacuum transport module of a machine for package printing.

For example, in the case of the successive processing of different (sheet) formats and/or die-cutting formats, modifications to the machine may be necessary. These modifications often require a large amount of time and as a result have a negative effect on the production costs. Furthermore, such modifications, if made incorrectly, can result in losses in quality in production.

### SUMMARY OF THE INVENTION

### Technical Problem

Therefore, a problem addressed by the present invention is that of creating an improvement compared with the prior art, making it possible, in particular, to make modifications to the machine such that these take little time to make and do not cause any losses in quality in subsequent production.

### Solution to the Problem According to the Invention

This problem is solved according to the invention by a device as claimed in the independent machine for post-processing a printing substrate claim.

Advantageous and therefore preferred developments of the invention will become apparent from the dependent claims and from the description and the drawings.

A machine according to the invention for post-processing a printing substrate, contains a die-cutting module for die-cutting the printing substrate, the die-cutting module having a die-cutting device, an upstream first nipping section and a downstream second nipping section for the printing substrate, a transport module for onward transport of the printing substrate, the transport module having at least one variable-length transport section, and a transfer device for transferring the printing substrate from the die-cutting module to a subsequent module. The transfer device contains a variable-length transfer section. The machine is characterized in that a stripping module is arranged as a subsequent module between the die-cutting module and the transport module. The stripping module is positioned in the processing direction of the machine depending on a sheet format, and in that the transfer device transfers the printing substrate from the die-cutting module to the stripping module. The length of the transport section and the length of the transfer section are settable according to the position of the stripping module.

### Advantageous Configurations and Effects of the Invention

The invention advantageously makes it possible to make changes to the machine such that these changes take little time to make and do not cause any losses in quality in subsequent production.

The invention is used for example in machines in industrial, i.e. highly productive and high-quality package printing or in the production (printing and post-processing) of packages such as folding boxes. The machine preferably processes and transports printing substrate webs and in the process creates-preferably during the die-cutting operation-cross-cut printing substrate sheets from the web, which are in turn post-processed and transported.

A (post-processing) machine according to the invention contains a positionable unit, i.e. the stripping module, and two variable-length units, i.e. the transport section and the transfer section. In this case, “positionable” means that the module is arranged at a first position for one (production) order and is arranged at a different position for another order, wherein the two positions differ from one another only horizontally and are (substantially) the same vertically. The module is thus moved horizontally. The positioning is preferably affected by movement in translation, for example on rails provided therefor, and is preferably driven by a motor. Furthermore, “variable-length” means that a length is changed in the horizontal direction from one (production) order to another. This changing of the lengths is preferably affected such that spacing changes, caused by the positioning, (substantially) between machine modules that are involved are compensated.

The invention affords the advantage that printing substrate to be processed by the machine in the processing direction thereof, on its way from the die-cutting module to the stripping module, through the stripping module and to the transport module, is always guided (onward) and in each case transferred reliably and in a controlled manner and, as a result, is always in its optimal (processing) position. Disruptive “floating” of the sheet is prevented. The machine consequently has high process safety overall, in particular high stripping accuracy, even at high processing rates. The quality of the products that are created, for example folding-box blanks, can be increased by the invention and printer's waste can be prevented or reduced.

In a machine according to the invention, a sheet die-cut by the die-cutting module is always guided by rollers on its way from the die-cutting module to the stripping module: preferably by the nipping rollers of the second nipping section, optionally by the nipping rollers of the third nipping section or optionally (and temporarily) by both nipping sections together. If, optionally, there is no third nipping section, a roller pair, guiding the sheet, of the stripping module may be present instead; this pair of rollers may be present within the stripping module.

The die-cutting module is preferably a flatbed die-cutter. The printing substrate is preferably in the form of a web and is cross-cut or cross die-cut (apart from the hold point, which is then severed) to form sheets. The machine may be in the form of a flatbed die-cutting machine. The machine may also comprise upstream printing units, for example flexographic printing units; in this regard, the machine may be a flexographic printing press with an inline flatbed die-cutter. The machine may preferably process cardboard in the form of a web and may preferably produce blanks for folding boxes.

The modification, according to the invention, of the length of the transport section and of the transfer section during conversion to a new format to be processed may in each case be carried out manually by the operating personnel; alternatively, it may in each case be affected by a motor and preferably automatically.

### Developments of the Invention

In the following text, preferred developments of the invention (developments for short) are described. These may also—unless technically precluded—be combined with one another.

One development may be characterized in that the stripping module has an upstream third nipping section for the printing substrate. Such a third nipping section may considerably improve the reliable conveying of the sheets.

One development may be characterized in that the first nipping section has at least two cooperating first nipping rollers. One development may be characterized in that the second nipping section contains at least two cooperating second nipping rollers. One development may be characterized in that the third nipping section contains at least two cooperating third nipping rollers. For cooperation, the respective rollers are preferably positioned against one another. One development may be characterized in that the nipping sections each comprise an upper roller and a lower roller. One development may be characterized in that the upper roller of the second nipping section is rubberized. One development may be characterized in that the lower roller of the second nipping section is coated. The upper and lower rollers of the two other nipping sections may also be configured in this way. The rubberization serves in particular for reliable guidance of the sheet to be transported.

One development may be characterized in that the spacing of the second nipping section from the stripping module or from the third nipping section is smaller than the sheet format. One development may be characterized in that the spacing of the stripping module or of the third nipping section from the adjustable roll of the transport section is smaller than the sheet format. The (manual or motor-driven) setting of the respective spacings to a size smaller than the sheet format to be transported, i.e. smaller than the sheet length in the transport direction, serves in particular for reliable guidance of the sheet to be transported, since the latter is then always guided by at least one roller or roll. The spacing of the second nipping section from the first nipping section may be larger than the sheet format. One development may be characterized in that the web is pushed into the die-cutting module intermittently by the first nipping section, the web is separated into successive sheets-apart from hold points—in the die-cutting module, and the sheets are completely separated from the web and conveyed by the second nipping section. One development may be characterized in that the sheets are then received by the stripping module or by the third nipping section. One development may be characterized in that the sheets are then received by the transport module, in particular by the vacuum belt and/or (inlet) roll thereof.

One development may be characterized in that the machine contains a control device for controlling the feed rate of the first nipping section, of the second nipping section and/or of the third nipping section (if the latter is present). One development may be characterized in that the second nipping section follows an acceleration profile of the first nipping section. One development may be characterized in that the third nipping section follows an acceleration profile of the first nipping section or of the second nipping section. The acceleration profiles of the respective nipping sections may also follow the acceleration profile of possible upstream printing units, in particular when starting up or shutting down the machine. The respective nipping sections may have separate drive motors, which are controlled by the control device. Preferably, all the abovementioned rollers and rolls rotate synchronously with one another, i.e. with the same sheet conveying rate.

One development may be characterized in that the machine contains a pivotable support. The support may be manufactured as a frame or a plate made of metal; a pair of rails may be arranged on the frame or plate. The movable modules (stripping module, transport module) may be mounted movably on the rails by way of rolls. One development may be characterized in that the support is pivotable about a vertical pivot axis. The pivoting is preferably motor-driven. One development may be characterized in that the pivot axis is arranged close to the die-cutting module. One development may be characterized in that the pivot axis is arranged close to the outlet side of the die-cutting module. In this case, “close” means preferably that the pivot axis is positioned at a minimum possible spacing (taking into account the technical and spatial conditions of the machine, including tolerances). One development may be characterized in that the stripping module is arranged on the support. One development may be characterized in that the transport module is arranged on the support. The stripping module and the transport module may be conjointly pivoted in this way. Thus, problems during post-processing that are caused by so-called “skew printing” can be avoided, since the modules- and thus also the components thereof, in particular tools and, for example, stripping needles—can be oriented in an error-free manner with respect to the (skew) print image.

One development may be characterized in that the variable-length transport section contains a circulating vacuum belt. One development may be characterized in that the variable-length transport section comprises an adjustable roll for the vacuum belt. One development may be characterized in that the adjustable roll is a deflection roll for the vacuum belt. One development may be characterized in that the adjustable roll is adjustable horizontally. One development may be characterized in that the variable-length transport section contains a telescopic device for setting a position of the roll. In this way, the roll can be positioned close to the stripping module and the sheet can be guided reliably on being transferred from the stripping module to the transport module. One development may be characterized in that the position of the adjustable roll is settable such that a spacing from the stripping module is at a minimum. One development may be characterized in that the variable-length transport section comprises at least one setting roll. In this case, “close” means preferably positioned at a minimum possible spacing (taking into account the technical and spatial conditions of the machine, including tolerances).

One development may be characterized in that the variable-length transfer section comprises a variable-length blind or tray for supporting the printing substrate. One development may be characterized in that the length of the blind or tray is adjustable horizontally. The blind may, for this purpose, comprise a retraction; the tray may, for example, be telescopically pushed together. One development may be characterized in that the blind or tray comprises an element for mounting on the stripping module or on the third nipping section thereof or, conversely, an element for mounting on the die-cutting module or on the second nipping section thereof. The mounting element may be formed, for example, in a hook-like manner and preferably comprise one or more hooks. One development may be characterized in that the blind comprises a textile or foil, for example a fabric, a fabric-reinforced tarpaulin, or a steel foil.

One development may be characterized in that the machine has, upstream of the die-cutting module, a feed module. One development may be characterized in that the machine has, upstream of the feed module, at least one printing unit, preferably several for CMYK multicolor printing. One development may be characterized in that the machine has, downstream of the transport module, a blank separating module.

The features and combinations of features disclosed in the above sections Technical field, Invention, and Developments, and in the following section Exemplary embodiments, represent—in any desired combination with one another—further advantageous developments of the invention.

Other features which are considered as characteristic for the invention are set forth in the appended claims.

Although the invention is illustrated and described herein as embodied in a machine for post-processing printing substrate, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic illustration in a longitudinal direction of a preferred exemplary embodiment of a machine according to the invention.

FIG. 2 shows (for clarity reasons) substantially the same illustration with further reference signs.

### DETAILED DESCRIPTION OF THE INVENTION

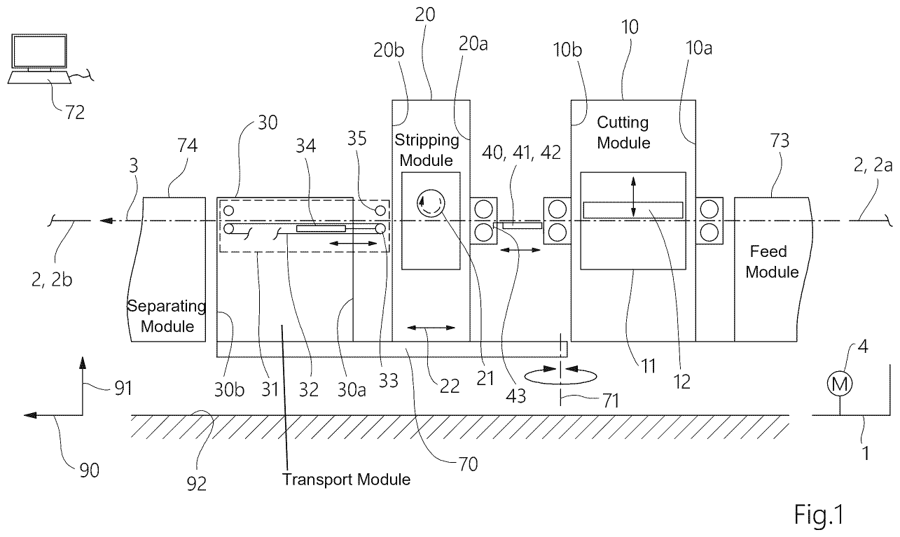

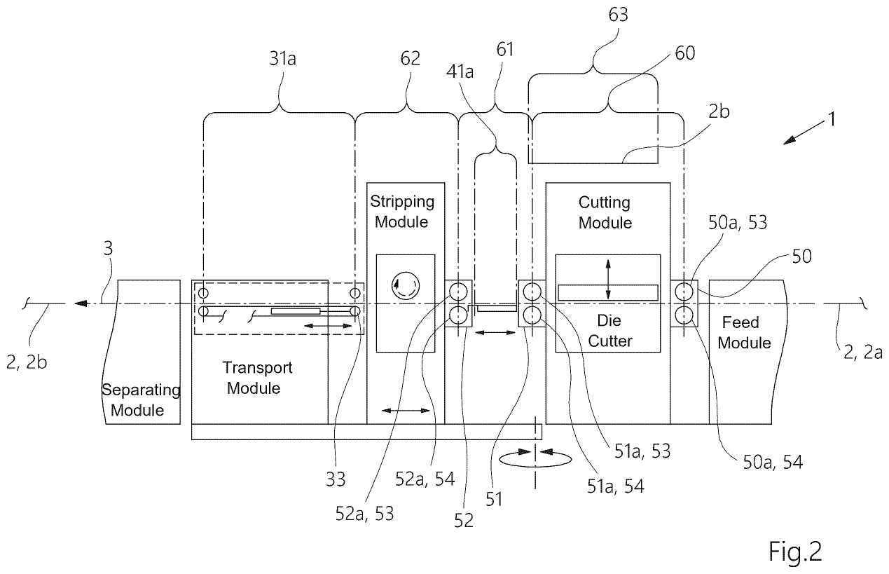

FIGS. 1 and 2 show a preferred exemplary embodiment of the invention and some of its preferred developments. Features that correspond to one another are provided with the same reference signs in the figures. Reference signs that repeat in the figures have been partially omitted for clarity purposes.

Referring now to the figures of the drawings in detail and first, particularly to FIGS. 1 and 2 thereof, there is shown a machine 1, which processes a—substantially horizontally—transported printing substrate 2, i.e. initially a web 2a and then sheets 2b produced by cross-cutting or cross die-cutting (and severing), and in particular post-processes same, i.e., for example, die-cuts it, strips it, and separates and delivers the blanks thus created. The printing substrate, made for example from cardboard, has preferably already been printed in a multicolored manner by upstream printing units (not illustrated), for example by a flexographic printing process. The printing substrate 2 is transported substantially in direction 3. For this transport, the machine 1 has at least one motor 4. With the machine 1, blanks for folding boxes can be produced.

The machine 1 has a die-cutting module 10 having an inlet side 10a and an outlet side 10b for the printing substrate 2, and having a die-cutting device 11, which in turn has a vertically movable die-cutting tool 12. The die-cutting module is preferably arranged in a fixed position, i.e. immovably, on a floor 92 of a production facility, for example a printing plant (for reasons of clarity, the machine is illustrated with a spacing from the floor).

Furthermore, the machine 1 has a stripping module 20 (as the module downstream of the die-cutting module 10) having an inlet side 20a and an outlet side 20b for the printing substrate 2 and having a rotating stripping tool 21. According to the invention, the stripping module 20 is variable in its position 22 in a horizontal direction 90, preferably movable in translation, for changing orders with different formats. To this end, the stripping module may be moved in translation on the floor 92 or on a support 70. For this purpose, rails (not illustrated) may be provided on the floor 92 or on the support 70.

Downstream of the stripping module 20, the machine 1 has a transport module 30 having an inlet side 30a and an outlet side 30b for the printing substrate 2. A transport section 31 of the transport module 30 has a length 31a that is variable (in a horizontal direction 90). The transport section 31 has, to this end, a variable-length vacuum belt 32, which is guided at least about a roll 33, preferably about a plurality of more than the two illustrated rolls, wherein the roll 33 is movable in a horizontal direction by means of a telescopic device 34 and is thus adjustable. The roll 33 cooperates with a setting roll 35 such that the printing substrate 2 is guided and in particular pulled reliably. The vacuum belt 32 may be guided about an adjustable compensating roll (not illustrated), as a result of the adjustment of which the path and thus the length of the belt can be modified or adapted in the direction of the stripping module 20.

Arranged between the two modules 10 and 20 is a transfer device 40 having a transfer section 41, which has a variable length 41a, for example an extendable blind 42 made of a fabric or a tarpaulin. The blind 42 may—as illustrated—be fastened to the die-cutting module 10 and be mounted on the stripping module 20 by means of an element 43, or vice versa (compared with what is illustrated).

The machine 1 preferably has three nipping sections for transporting the printing substrate 2: a first nipping section 50 with two cooperating first nipping rollers 50a; a second nipping section 51 with two cooperating second nipping rollers 51a; and a third nipping section 52 with two cooperating third nipping rollers 52a; wherein each pair of nipping rollers contains an upper roller 53 and a lower roller 54 with respect to the printing substrate 2. Preferably, each nipping section is driven by a separate servomotor 4. The drive is preferably affected intermittently and in a manner coordinated with the stroke of the die-cutting tool 12. The machine 1 may also preferably contain only two nipping sections, the first nipping section 50 and the second nipping section 51, i.e. the third nipping section may be omitted.

The two FIGS. 1 and 2 also show different spacings: a spacing 60 between the first nipping section 50 and the second nipping section 51; a spacing 61 between the second nipping section 51 and the third nipping section 52; a spacing 62 between the third nipping section 52 and the roll 33. Moreover, the format or the length 63 of an example of a sheet 2b is shown (the sheet is in this case illustrated above the die-cutting module 10 only for reasons of clarity).

It is apparent that the spacings 61 and 62 are shorter than the length 63 of the sheet 2b. In practice, the spacings 61 and 62 will only be slightly shorter than the length 63 of the sheet 2b. This ensures that the sheet 2b is always guided by one of the second nipping section 51, the third nipping section 52, the vacuum belt 32 or the roll 33 (together with the setting roll 35) and never “floats”. The spacing 60 may be somewhat larger than the length 63, since the sheet 2b has not yet been fully separated from the web 2a in the region of the die-cutting module 10 and is only severed from the web 2a by the feed of the second nipping section 51.

The two FIGS. 1 and 2 also show the support 70, which is arranged so as to be pivotable about a vertical axis 71. The stripping module 20 and the transport module 30 are preferably arranged on the support 70 and are thus pivotable together therewith. A pivot drive (not illustrated), for example a motor and a drive spindle, may be arranged at the end-opposite to the pivot axis—of the support 70. The stripping module 20 and the transport module 30 are preferably received movably (tracks and rolls) on the support).

The machine 1 also contains a control device 72, preferably a digital computer, which controls the individual components of the machine, in particular the modules 10, 20 and 30 together with their nipping sections 50, 51 and 52 and also the roll 33, such that the printing substrate 2 is guided and transported reliably in coordination with the feed of a web 2b and the die-cutting operation. An upstream feed module 73, which changes the continuous web feed into an intermittent one, and a downstream blank separating module 74 may likewise be controlled by the control device 72.

The following is a summary list of reference numerals and the corresponding structure used in the above description of the invention:
1 Machine, post-processing machine
2 Printing substrate
2a Web
2b Sheet, cross-cut from web
3 Processing direction, transport direction
4 Motor(s)
10 Die-cutting module
10a Inlet side
10b Outlet side
11 Die-cutting device
12 Die-cutting tool
20 Stripping module as downstream module
20a Inlet side
20b Outlet side
21 Stripping tool
22 Variable position of the stripping module
30 Transport module
30a Inlet side
30b Outlet side
31 Transport section
31a Variable length of the transport section
32 Vacuum belt
33 Roll, Inlet roll
34 Telescopic device
35 Setting roll
40 Transfer device
41 Transfer section
41a Variable length of the transfer section
42 Blind or tray
43 Element for mounting
50 First nipping section
50a First nipping rollers
51 Second nipping section
51a Second nipping rollers
52 Optional third nipping section
52a Optional third nipping rollers
53 Upper roller
54 Lower roller
60 Spacing of first and second nipping sections
61 Spacing of second and third nipping sections
62 Spacing of third nipping section and roll
63 Sheet format, sheet length
70 Support
71 Pivot axis
72 Control device
73 Feed module
74 Blank separating module
90 Horizontal
91 Vertical
92 Floor

1. A machine for post-processing a printing substrate, the machine comprising:
a die-cutting module for die-cutting the printing substrate, said die-cutting module having a die-cutter;
an upstream first nipping section;
a downstream second nipping section for the printing substrate;
a transport module for onward transport of the printing substrate, said transport module having at least one variable-length transport section;
a stripping module disposed between said die-cutting module and said transport module, said stripping module being positionable in a processing direction of the machine depending on a sheet format; and
a transfer device for transferring the printing substrate from said die-cutting module to said stripping module, said transfer device containing a variable-length transfer section, said transfer device transferring the printing substrate from said die-cutting module to said stripping module, wherein a length of said at least one variable-length transport section and a length of said variable-length transfer section being settable according to a position of said stripping module.

2. The machine according to claim 1, wherein said stripping module has an upstream third nipping section for the printing substrate.

3. The machine according to claim 2, wherein:
said at least one variable-length transport section has an adjustable roll;
a spacing of said downstream second nipping section from said stripping module or from said upstream third nipping section is smaller than the sheet format; and/or
a spacing of said stripping module or of said upstream third nipping section from said adjustable roll of said at least one variable-length transport section is smaller than the sheet format.

4. The machine according to claim 3, further comprising a controller for controlling a feed rate of said upstream first nipping section, of said downstream second nipping section and/or of said upstream third nipping section.

5. The machine according to claim 1, further comprising a pivotable support.

6. The machine according to claim 5, wherein said pivotable support is pivotable about a vertical pivot axis.

7. The machine according to claim 5, wherein said stripping module is disposed on said pivotable support.

8. The machine according to claim 1, wherein said at least one variable-length transport section has a circulating vacuum belt.

9. The machine according to claim 8, wherein said at least one variable-length transport section has an adjustable roll for said circulating vacuum belt.

10. The machine according to claim 9, wherein said at least one variable-length transport section has a telescopic device for setting a position of said adjustable roll.

11. The machine according to claim 1, wherein said variable-length transfer section contains a variable-length blind or tray for supporting the printing substrate, and said variable-length blind or tray contains an element for mounting on said stripping module or on said downstream second nipping section thereof.
